(19) United States
(12) Patent Application Publication
(10) Pub. No.: US 2011/0238545 A1
(43) Pub. Date: Sep. 29, 2011

(54) METHOD AND APPARATUS FOR PROVIDING BUNDLED SERVICES

(75) Inventors: Nabil Ruh Fanaian, Duluth, GA (US); Gregory Montgomery, Sugar Hill, GA (US); Chris Stoner, Hubbardston, MA (US)

(73) Assignee: Nokia Corporation, Espoo (FI)

(21) Appl. No.: 12/732,514

(22) Filed: Mar. 26, 2010

(51) Int. Cl. G06F 15/173; G06Q 30/00

(52) U.S. Cl. 705/34; 709/226

(57) ABSTRACT

Techniques for supporting bundled services of network operators and service providers include generating a view to be presented on a display, the view comprising data that indicates a service provided by a vendor over a network. It is determined whether the service is associated with a service feature of a network operator of at least a portion of the network. If the service is associated with the service feature of the network operator, then data that indicates the service feature of the network operator is inserted into the view. The view is provided for transmission over the network.

### BACKGROUND

Service providers and device manufacturers (e.g., wireless, cellular, etc.) are continually challenged to deliver value and convenience to consumers by, for example, providing compelling network services. The service chosen by a consumer from a service vendor is often delivered to a consumer's device, such as a mobile terminal, that obtains access to a communications network through one network operator. The network plans offered to the consumer by the network operator are not all well suited for all services. For example, a service that provides news feeds through a short message service (SMS) to a consumer's phone is not well suited for use with a network plan that does not include text or that charges a high price for each text message. Similarly, a service that provides email or navigation is not well suited for a cellular telephone network plan that does not include data or that charges a high price for each thousand characters (kilobyte, kB) or million characters (Megabyte, MB) of data transferred to the consumer's cell phone.

Because the consumer typically forms contracts with the network operator in separate transactions from choices of services available from network service providers, the consumer is often burdened with the responsibility to select suitable combinations of plans and services. As a result, the consumer is often forced to make several changes to the service or network operator plans, causing wasteful redundant expenditures of memory, processing, battery life and bandwidth resources on the consumer's mobile equipment, and wasted processing on the operator's equipment and wasted bandwidth on the network. Furthermore, a consumer may find a particular service too expensive or inconvenient, given a present network operator plan, and cancel a request to add a service. Thus, both service provider and network operator miss out on the opportunity for increased business.

### SOME EXAMPLE EMBODIMENTS

Therefore, there is a need for an approach for bundled services of network service providers and service features of network operators.

According to one embodiment, a method comprises generating a view to be presented on a display, the view comprising data that indicates a service provided by a vendor over a network. The method further comprises determining whether the service is associated with a service feature of a network operator of at least a portion of the network. If the service is associated with the service feature of the network operator, then data that indicates the service feature of the network operator is inserted into the view. The method further comprises providing the view for transmission over the network

According to one embodiment, a method comprises facilitating access to an interface to allow access to a service via a network, the service configured to generate a view to be presented on a display, the view comprising data that indicates a particular service provided by a vendor over a network. The service is further configured to determine whether the particular service is associated with a service feature of a network operator of at least a portion of the network. The service is further configured to insert into the view data that indicates the service feature of the network operator, if the particular service is associated with the service feature of the network operator. The service is further configured to provide the view for transmission over the network.

According to another embodiment, an apparatus comprises at least one processor and at least one memory including computer program code. The at least one memory and the computer program code are configured to, with the at least one processor, cause the apparatus to at least generate a view to be presented on a display. The view comprising data that indicates a service provided by a vendor over a network. The apparatus is further caused to determine whether the service is associated with a service feature of a network operator of at least a portion of the network. The apparatus is further caused to insert into the view data that indicates the service feature of the network operator, if the service is associated with the service feature of the network operator. The apparatus is further caused to provide the view for transmission over the network.

According to another embodiment, a computer-readable storage medium carrying one or more sequences of one or more instructions which, when executed by one or more processors, cause, at least in part, an apparatus to generate a view to be presented on a display. The view comprising data that indicates a service provided by a vendor over a network. The apparatus is further caused to determine whether the service is associated with a service feature of a network operator of at least a portion of the network. The apparatus is further caused to insert into the view data that indicates the service feature of the network operator, if the service is associated with the service feature of the network operator. The apparatus is further caused to provide the view for transmission over the network.

According to another embodiment, an apparatus comprises means for generating a view to be presented on a display, the view comprising data that indicates a service provided by a vendor over a network. The apparatus further comprises means for determining whether the service is associated with a service feature of a network operator of at least a portion of the network. The apparatus further comprises means for inserting, into the view, data that indicates the service feature of the network operator, if the service is associated with the service feature of the network operator. The apparatus further comprises means for providing the view for transmission over the network.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of bundling services of network service providers and network operators, according to one embodiment;

FIG. 2 is a diagram of the components of cross-operator service bundle support module, according to one embodiment;

FIG. 3A is a diagram of a matched bundles data structure; according to an embodiment;

FIG. 3B is a diagram of an activate operator feature message; according to an embodiment;

FIG. 4 is diagram of a user interface utilized in bundling services of network service providers and network operators, according to an embodiment;

FIG. 5 is a time sequence diagram of messages exchanged for bundling services of network service providers and network operators, according to an embodiment;

FIG. 6 is a flowchart of a process for bundling services of network service providers and network operators, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset) that can be used to implement an embodiment.

### DESCRIPTION OF SOME EMBODIMENTS

Examples of a method, apparatus, and computer program are described for bundling services of network service providers and network operators. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term network operator refers to any entity that operates at least a portion of a communications network and provides access to the communications network for at least some consumer equipment, including access for mobile terminals such as cellular telephones (cell phones). A network service provider is any entity that provides services other than access to the communication network for a consumer, including any vendor that offers devices or services through the communication network. For convenience the network service operator is referenced to hereinafter as the operator; while the network service provider is referenced hereinafter as a vendor, even though services might be offered free-of-charge. Although various embodiments are described with respect to obtaining email service on a cellular telephone, it is contemplated that the approach described herein may be used with other services or devices offered for sale or free-of-charge, such as text messaging, instant messaging, mapping, navigation, social networking, music, video, gaming, handsets, ring tones, ticket, coupons, computer peripherals, used items, new items, residential or commercial real estate, and personal services, offered through a cellular telephone or other mobile or fixed consumer device accessing the communication network through a network operator.

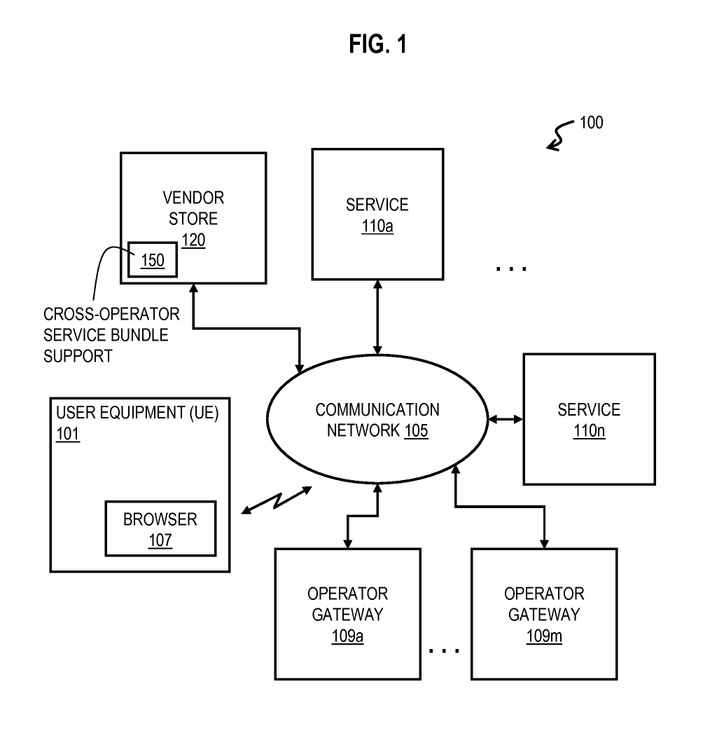

FIG. 1 is a diagram of a system capable of bundling services of network service providers and network operators, according to one embodiment. As described above, when a consumer signs up for network services, such as email from an email service, the service might not be compatible with the service features of the contract already established with the cellular telephone network operator.

To address this problem, a system 100 of FIG. 1 introduces the capability to present consumers with bundled operator and vendor services that are compatible. As shown in FIG. 1, the system 100 comprises user equipment (UE) 101 having connectivity to vendor store 120 and other network services 110a through 110b (collectively referenced hereinafter as network services 110) via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth™, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

The UE 101 accesses the network 105 through a home network operator with whom the consumer associated with UE 101 has a contract. The network operators each control one or more of a plurality of operator gateway nodes 109a through 109m on network 105 (collectively referenced hereinafter as operator gateway nodes 109) through which messages from their consumers are passed and where service features are enforced. While roaming, mobile user equipment, e.g., UE 101, accesses the network 105 through equipment of a different operator, which confers with the operator gateway node (e.g., operator gateway node 109a) of the home network operator to enforce service features for which the consumer has contracted.

According to various embodiments, the vendor store process 120 includes a cross-operator service bundle support module 150 that causes one or more of network services 110 to be bundled with one or more compatible service features available from the operator gateway 109 of the home network operator (e.g., operator gateway 109a) and presented as a bundle to a consumer who uses UE 101.

By way of example, the UE 101, the cross-operator service bundle support module 150, the network services 110 and the operator gateways 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages.

The vendor store 120 is a process, such as a web server process, through which multiple network services 110 can be procured, either by registration or payment or some combination. In the illustrated embodiment, the UE 101 includes browser 107 for communicating with the vendor store 120 and one or more network services 110. The use of protocols and the connection of the vendor store 120 to the network 105 facilitates access, including granting access rights, to an interface to allow access to the cross-operator service bundle support module 150 via a network.

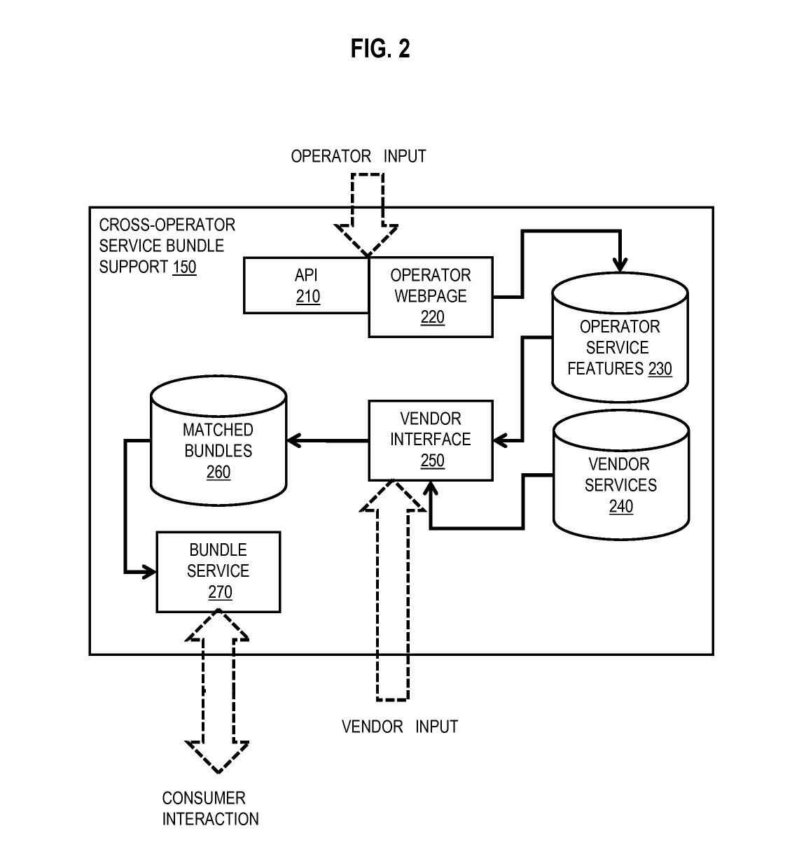

FIG. 2 is a diagram of the components of cross-operator service bundle support module 150, according to one embodiment. By way of example, the cross-operator service bundle support module 150, includes one or more components for bundling service features of one or more operators (hence the name “cross-operator”) with network services available through the vendor store process 120, such as one or more of network services 110. It is contemplated that the functions of these components may be combined in one or more components on a single node of the network or performed by other components of equivalent functionality on one or more nodes of the network. In the illustrated embodiment, the cross-operator service bundle support module 150 includes an application programming interface (API) module 210, an operator webpage module 220, an operator service features data structure 230, a vendor services data structure 240, a vendor interface module 250, a matched bundles data structure 260, and bundle service module 270.

Network operators can have their service features, such as one or more service plans, bundled with the vendor's services by entering data describing the operator features into the cross-operator bundle support module 150. The application programming interface (API) module 210 is configured to accept commands from the operator that add descriptions of operator features, such as service plans, to the operator service features data structure 230. As is well know, an API provides published commands that can be invoked from external processes on the network to cause the module 150 to perform certain functions. Alternatively, or in addition, the operator webpage module 220 presents one or more web pages and embedded forms to a browser on equipment of the network operator (such as operator gateway 109) that prompts an agent of the operator for information to be stored in the operator service features data structure 230.

The advantage to the operator of entering operator service features is that consumer choices of certain vendor services can induce the consumer to upgrade to a higher level service feature from the operator, thus increasing business for the operator, without repeated, trial-and-error changes of network service features that waste valuable resources on user equipment, such as processor and battery life. An example means to achieve this advantage is the API module 210. Another example means is the operator webpage module 220. In the illustrated embodiment, the network operator is different from a vendor of the network services 110. However, in some embodiments, the network operator is the same as the vendor of one or more network services 110.

In various embodiments, one or more network operators are notified of the API or the operator webpage network address, e.g., the universal resource locator (URL), or both by the vendor; and the network operator is invited to input data describing their network service plans. Example data describing a network operator service plan includes a feature code that uniquely identifies the service feature, a description of the services included, a unit price, and any discount price for bundling with a vendor service to induce consumer action. Network operator input to either the API module 10 or operator webpage module 220 is depicted in FIG. 2 by the dashed arrow labelled operator input. An advantage of allowing network operator input is to allow a mobile network operator to define the rules for consumer use of various service options.

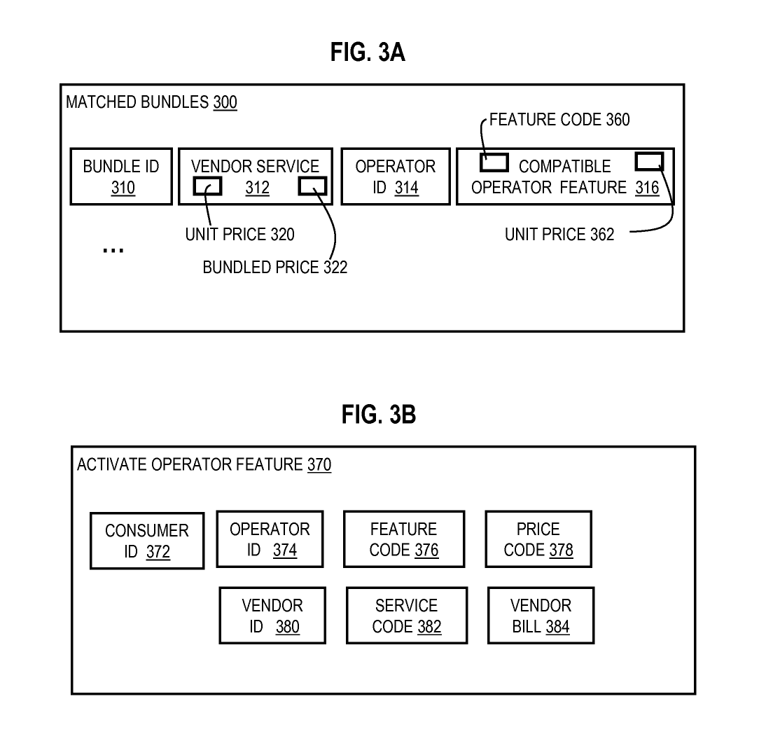

The operator service features data structure 230 holds data that indicates the network operator service features, such as one or more service plans. In order to accept service feature data from multiple network operators, the data structure 230 includes data that uniquely indicates the service operator, such as a network address of an associated operator gateway 109, as well as data that indicates the feature code, a description and a unit price, as well as a discounted price, if any, as described in more detail below with reference to FIG. 3A. The operator service feature data structure is an example means to store network operator data. This offers the technical advantage of making operator data essentially immediately available when a vendor attempts to define bundled services. This rapid availability reduces bandwidth consumption on the network (e.g., network 105) and processing delays on the vendor equipment (e.g., on hosts for vendor store 120).

The vendor services data structure 240 holds data that indicates one or more network services 110 available for registration or purchase, or both, from an entity called a vendor that provides and maintains vendor store 120. For example, a manufacturer of mobile phones is a vendor that provides various support services for the mobile phones of their manufacture, such as an email service, a text service, an instant messaging service, a browser, a navigation service, a music service, a video service, a camera and photograph service, a broadcast radio or television service, a social network service, and games services, among others, or some combination, in addition to basic cellular telephone service. For example, vendor service data structure includes data that uniquely indicates the service as well as data that indicates a description and a unit price, as well as a discounted price when bundled with another vendor or network operator service, if any, as described in more detail below with reference to FIG. 3A.

The vendor interface module 250 is configured to accept input from an agent of the vendor who associates each vendor service in data structure 240 with one or more compatible operator service features in data structure 230. This includes associating vendor services with each operator that has input data through the API module 210 or operator webpage module 220. Network service vendor input to the vendor interface module 250 is depicted in FIG. 2 by the dashed arrow labelled vendor input. As a result of vendor input, data is input into the matched bundles data structure 260, described in more detail below with reference to FIG. 3A. Thus, vendor interface module 250 is configured to cause, at least in part, actions that result in storing, into a data structure 260, a different service in association with a service feature of a network operator of at least a portion of the network, in response to receiving data that indicates the service feature of the network operator.

The vendor interface module 250 is an example means to provide the advantage of freeing the consumer from the burden of knowing what network operator features are useful for various network services and reducing the wasteful repetition of operator service feature subscription on the UE 101, which expends processor and bandwidth on the UE 101, as the consumer attempts to match the correct service features by trial and error. The vendor is in a better position to match the network services with the operator features. For example, an unsophisticated consumer may not realize that email is considered a data service and not a text messaging service so that an operator service plan that includes unlimited text messaging is not equivalent to unlimited email service. After learning of the unfortunate difference, the UE 101 will be operated by the consumer to change the operator service feature, thus unnecessarily wasting resources on the UE 101 and network 105.

The bundle service module 270 is configured to present bundled services to a consumer, e.g., through the browser 107 on UE 101 or some other client process on UE 101, and detect and respond to a consumer selection of the bundled service. In some embodiments, the bundles presented are based, at least in part, on the context information associated with the UE 101. Context information indicates the circumstances of a consumer using UE 101, such as make and model of equipment, the contracts that obligate the consumer, or the current services to which the consumer subscribes, among others, or some combination. The response includes activating the selected service and notifying the network operator of the compatible service feature in the bundle. Message exchanges with the consumer, e.g., through browser 107 or some other client process on UE 101, are depicted in FIG. 2 by the dashed double-headed arrow labelled consumer interaction. Thus, bundle service module 270 causes, at least in part, actions that result in sending, to the network operator, a message that indicates a consumer and the service feature, in response to receiving, from the consumer, data that indicates the service associated with the service feature of the network operator. Thus the consumer is insulated from making separate manual and error prone requests to the vendor of the network services and to the network operator. This provides the advantage of avoiding wasteful expenditure of computational, storage and bandwidth resources on the UE 101 and network 105. The bundle service module 270 is an example means to achieve this advantage.

Although processes, modules and data structures are depicted in FIG. 2 as integral portions of module 150, in other embodiments, one or more processes, modules, data structures or portions thereof are omitted or arranged in a different order on one or more network nodes, or one or more additional processes, modules and data structures are included, or the module 150 is changed in some combination of ways.

FIG. 3A is a diagram of a matched bundles data structure 300; according to an embodiment. Data structure 300 is a particular embodiment of matched bundles data structure 260, depicted in FIG. 2. Matched bundles data structure 300 includes, for each bundle, a bundle identifier (ID) field 310, a vendor service field 312, an operator identifier (ID) field 314 and a compatible operator feature field 316. Other bundles are indicated by ellipsis. Although data structures and fields are depicted in FIG. 3A as integral blocks in a particular order for purposes of illustration, in other embodiments, one or more data structures or fields, or portions thereof, are omitted or arranged in a different order in one or more data structures or databases on one or more network nodes, or one or more additional fields are included, or the data structure is changed in some combination of ways. Thus, the matched bundles data structure 260 includes a plurality of records, each record holding data that indicates a unique association of one service (different from the vendor store) of a plurality of services different from the vendor store with one or more service features of one or more network operators.

The bundle ID field 310 holds data that uniquely indicates a particular bundle such as a sequence number or index key in a database assigned as bundles are added to the data structure 300.

The vendor service field 312 holds data that indicates a vendor service, e.g. text with a description of the service suitable for presentation to a consumer. In the illustrated embodiment, the vendor service field 312 includes a unit price field 320 and a bundled price field 322. The unit price field 320 holds data that indicates the price for the service, if any. The bundle price field 322 holds data that indicates the unit price for the vender service bundled with the compatible operator feature. Any method may be used to determine the bundled price, including adding the unit price for the vendor service to the unit price for the operator feature, or adding a discounted price for the vendor service to the unit or discounted price, if any, of the operator feature. In some embodiments, the vendor service field 312 is an entry in the vendor services data structure 240, and the matched bundles data structure 260 includes simply a pointer to that entry in that vendor services data structure 240. Use of a pointer is an example means to achieve the advantage of conserving storage space on the vendor equipment by not storing the vendor service data fields 312 more than once.

The operator ID field 314 holds data that uniquely indicates a network operator. Any method may be used to indicate the network operator including the operator name or the address of the operator gateway 109 or a process thereon. The compatible operator feature field 316 holds data that describes the operator feature, such as a telephone only plan, a phone and limited text plan, a phone and text and photograph image transmission plan, a phone and unlimited text plan, a phone and limited data plan, and a phone and unlimited text and data plan. In the illustrated embodiment, the compatible operator feature field 316 includes a feature code field 360 and a unit price field 362. The feature code field 360 holds data that uniquely identifies the operator feature for the particular operator indicated in field 314. The unit price field 362 holds data that indicates the unit price for the feature, such as dollars per month of use of the feature. In some embodiments, the operator ID field 314 and operator feature field 316 are in an entry in the operator service features data structure 230, and the matched bundles data structure 260 includes simply a pointer to that entry in that operator service features data structure 230. Use of a pointer is an example means to achieve the advantage of conserving storage space on the vendor equipment by not storing the operator feature data fields 314 and 316 more than once.

After the consumer has made a selection of one of the bundles presented by the bundle service module 270, the selected services are activated by the vendor and a message is sent to the network operator about the operator service feature in the selected bundle. Thus the bundle service module 270 causes, at least in part, actions that result in providing the selected service to the consumer. FIG. 3B is a diagram of an activate operator feature message 370; according to an embodiment. Although messages and fields are depicted in FIG. 3B as integral blocks in a particular order for purposes of illustration, in other embodiments, one or more messages, fields or portions thereof are omitted or arranged in a different order in one or more messages, or one or more additional fields are included, or the message is changed in some combination of ways. The activate operator feature message 370 may be formatted according to any protocol known in the art.

In an example embodiment, the message 370 is formatted according to a roaming protocol, as is well known in the art. For example, usage by a subscriber in a visited network is captured in a file called the TAP (Transferred Account Procedure) file for GSM/CIBER (Cellular Intercarrier Billing Exchange Roamer). The TAP/CIBER file is transferred to the home network; and contains details of the calls made by the subscriber, including location, calling party, called party, time of call and duration, among other details. The TAP/CIBER files are rated as per the tariffs charged by the visited operator. The home operator then bills these calls to its subscribers and may charge a mark-up/tax applicable locally. Typically, a roaming agreement needs to be in place between the entity sending the TAP/CIBER file and the home network. This agreement is established after a series of testing processes called IREG (International Roaming Expert Group) and TADIG (Transferred Account Data Interchange Group). While the IREG testing is to test the proper functioning of the established communication links, the TADIG testing is to check the billability of the calls.

In some embodiments, the activate operator feature message 370 is sent to a third party which has the roaming agreement, and the third party reformats the data from the message 370 into a TAP/CIBER file. Thus, in some embodiments, sending, to the network operator, the message that indicates the consumer and the service feature further comprises sending to the network operator the message formatted according to a roaming message protocol. An advantage of a standard roaming protocol is that the vendor need not establish separate protocols and agreements with each network vendor, but by contracting with the roaming standard, or a third party that is already contracted to the standard, one contract satisfies the need to interact with multiple network operators. The standard roaming protocol is an example means to achieve this advantage.

In some embodiments, the activate operator feature message 370 is formatted according to a custom protocol, such as a web service protocol, negotiated with one or more network operators.

In the illustrated embodiment, the activate operator feature message 370 includes a consumer identifier (ID) field 372, an operator identifier (ID) field 374, a feature code field 376, a price code field 378, a vendor identifier field 380, a service code field 382 and a vendor bill field 384. In some embodiments, one or more of these fields are omitted. For example, in some embodiments, the activate operator feature message includes only the consumer ID field 372 and the feature code field 376.

The consumer ID field 372 holds data that uniquely identifies a consumer to the home network operator, for billing purposes. The system 100 authenticates a user to get a user identifier suitable for billing by the operator, such as a subscriber identifier for the consumer. The data in the consumer ID field 372 can be a Mobile Subscriber Integrated Services Digital Network Number (MSISDN, which is a cell telephone number) or some other identifier defined by the operator, such as an International Mobile Subscriber Identity (IMSI) identifier, an email address or Short Message Service (SMS) short code. IMSI is a unique 15-digit code used to identify an individual user on a global system for mobile communications (GSM) network. An IMSI value is typically stored on a Subscriber Identity Module (SIM card), a device used to store information in many mobile phones, especially for advanced features.

The operator ID field 374 holds data that indicates the network operator to which the message 370 is directed. In some embodiments, this field is included in an Internet Protocol (IP) header of an IP message sent to a particular operator gateway 109. In some embodiments, using a TAP file or other roaming protocol, the operator ID field is superfluous because the operators determine which is involved by recognizing the consumer ID in field 372 for their own subscribers. In some embodiments, the consumer is not yet a customer of the operator. For example, the consumer is a customer of a different operator but is willing to switch operators in order to obtain a better bundled price for a desired network service 110. Similarly, in some embodiments, the consumer is not yet a customer of any network operator but is willing to select the operator in order to obtain a desirable bundled price for a desired network service 110. In these embodiments, the selected network operator is indicated in field 374 of the message 370.

The feature code 376 holds data that indicates the operator service feature that is being invoked for the bundled service based on the consumer selection. This value is originally provided by the operator and stored in field 360 in the operator service features data structure 230 and matched bundles data structure 260. The feature code field 376 is an example means to achieve the advantage of concisely indicating the feature to the network operator, thus saving bandwidth on the network.

The price code field 376 holds data that indicates which of multiple pricing options is to be applied. For example, if the operator offers the vendor a discount to encourage use of the service feature, then the price code field 378 holds data that indicates whether the standard or discounted price is to be applied to the consumer identified in field 372. Thus, in some embodiments, sending, to the network operator, the message that indicates the consumer and the service feature further comprises including in the message data that indicates a price for the service feature. In some embodiments, no discounts or other price variations are offered by the network operator and field 378 is omitted. The price code field 378 is an example means to achieve the advantage of price flexibility without excessive use of bandwidth to negotiate prices between the operator and the vendor each time a consumer invokes a service.

In some embodiments that involve the operator billing the consumer for the services provided by the vendor, the message 370 includes the vendor ID field 380, the service code field 382 and the vendor bill field 384. In some embodiments, the operator does not bill for the vendor services and field 380, field 382 and field 384 are omitted. Omitting fields 380, 382 and 384 is an example means to achieve the advantage of conserving bandwidth on the network when the operator does not bill for the vendor.

The vendor ID field 380 holds data that indicates the vendor that is providing the vendor store process 120, such as the cell phone manufacturer, and offering one or more services to be bundled with the operator service features. Any method may be used to identify the vendor, such as a network address of the vendor store process 120 or an identifier established as part of the roaming agreement. The service code field 382 holds data that indicates one or more of services 110 procured through the vendor. The data in this field is used to indicate the service on the bill presented to the consumer. The vendor bill field 384 holds data that indicates the amount to bill the consumer and payment due to the vendor from the operator, such as a monthly fee based on the unit price indicated in field 320 or on the discounted price for the bundle indicated in field 322. Thus, in some embodiments, sending, to the network operator, the message that indicates the consumer and the service feature further comprises including in the message data that indicates a charge to the consumer for the network service 110.

In some embodiments in which the network operator is selected based on the bundled services, the consumer is without the user equipment on which the service is provided and it is desirable that the user equipment be activated, configured with the service and shipped or picked up or otherwise delivered to the consumer. For example, the user has visited the cellular telephone manufacturer vendor store 120 via a browser on a different device, such as a laptop computer. Thus, in some embodiments, the bundle service module 270 is further configured to cause, at least in part, actions that result in delivering, to the consumer, new equipment configured to access the different service with the service feature of the network provider.

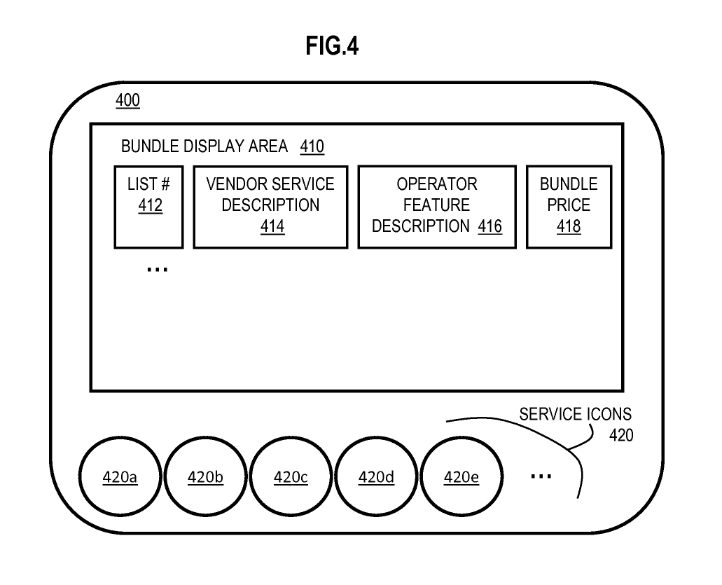

FIG. 4 is diagram of a user interface 400 utilized in bundling services of network service providers and network operators, according to an embodiment. For example, the user interface is a view presented on a display screen of UE 101 by browser 107 based on a webpage sent by the vendor store process 120 as modified by the cross-platform service bundle support module 150. The user interface 400 includes one or more service icons 420, including icon 420a, icon 420b, icon 420c, icon 420d, icon 420e among others indicated by ellipsis, each representing a different category of services available from the vendor, such as messaging services, social networking services etc. As used herein, an icon is a set of picture elements, called pixels, for presentation on a video display device. The user interface 400 also includes bundle display area 410 that presents a list of bundled services for a selected category. Any method may be used to select a category. As used herein, a view is a collection of one or more icons or display areas.

In the illustrated embodiment, the bundle display area 410 is a portion of the interface 400 where are listed bundled vendor services and operator service features. Each bundle includes a list number area 412, a vendor service description area 414, a compatible operator feature description area 416 and a bundle price area 418. Additional bundles are indicated by ellipsis. The bundles present in area 410 are example means of clearly presenting to a consumer the association between vendor services and operator service features, thus achieving the advantage of avoiding wasteful bandwidth and processing expenditures for repeated changes to operator services due to misunderstanding of the appropriate features by a naïve consumer.

The list number area 412 includes pixels that display information that indicates a unique identifier for the bundle, such as a sequential number or the bundle ID from field 310. The vendor service description area 414 includes pixels that display information that indicates a description of the service, such as an icon of an envelope and text stating “instant message service” or “email service” or “text messaging service.” The operator feature description area 416 includes pixels that display information that indicates the compatible network operator service features, such as the operator company logo and text stating “phone and text up to 300 messages” or “phone and unlimited text” for text or instant messaging. The bundle price area 418 includes pixels that display information that indicates a unit price for the bundled service, such as “$50 per month” or “$0.50 per message” or “$1 per megabyte.” Table 1 shows information in an example bundle display area.

TABLE 1
Example bundle display area for messaging categories.

| List # | Vendor Service | Operator Feature | Bundle Price |
|---|---|---|---|
| 1117 | Text message | [logo] phone | $0.05 per text up |
| | service | including 300 | to 300 plus $0.55 |
| | | texts | per text above 300 |
| 1118 | Text message | [logo] phone with | $50 per month |
| | service | unlimited texts | |
| 1119 | Email service with | [logo] phone with | $5 per month plus |
| | 1 Gigabyte storage | 10 Megabytes (Mb) | $5.50 per 10 MB |
| | | data | over 10 MB |
| 1120 | Email service with | [logo] phone with | $105 per month |
| | 1 Gigabyte storage | unlimited text and | |
| | | data | |

A user is also prompted to select a category, or a bundle within a category, by operating a pointing device associated with the display, such as a cursor with up/down and left/right control keys, or a touch screen, well known in the art. Thus, the bundle service module 270 causes, at least in part, actions that result in sending to equipment of the consumer data from the matched bundles data structure 260. Furthermore, bundle service module 270 causes, at least in part, actions that result in causing to be presented to the consumer a bundle of the service (different from module 150) and the associated service feature of the network operator from the data structure and a prompt to select the bundle.

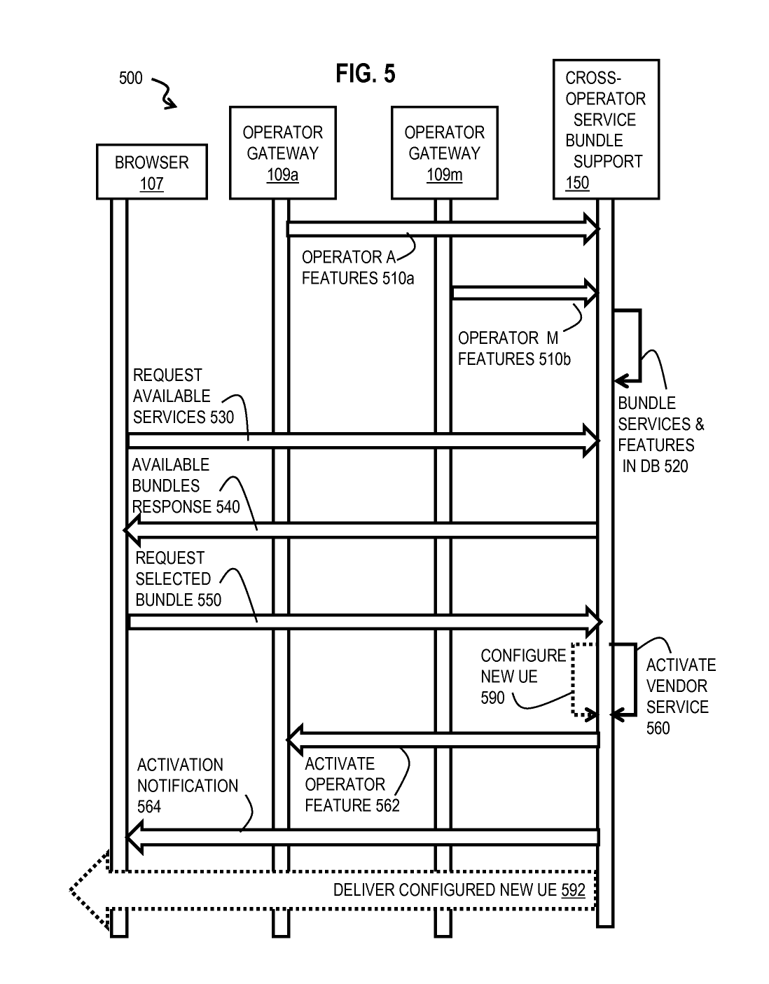

FIG. 5 is a time sequence diagram 500 of messages exchanged for bundling services of network service providers and network operators, according to an embodiment. Time increases downward in this diagram. A network process on the network is represented by a vertical bar. A message passed from one process to another is represented by horizontal arrows. A step performed by a process is indicated by a box or looping arrow overlapping the process at a time sequence indicated by the vertical position of the box or looping arrow. Processes represented in FIG. 5 include the cross-operator service bundle support module 150, one or more operator gateway nodes 109, such as operator gateway node 109a and operator gateway node 109b, and a browser 107 on UE 101, all depicted in FIG. 1.

In one or more messages 510a, an agent of a first network operator (Operator A), e.g., using operator gateway 109a, inputs data about one or more service features of Operator A. For example, data for field 314 and field 316 are provided in one or more messages 510a and stored in operator service features data structure 230. Similarly, in one or more messages 510b, an agent of a different second network operator (Operator BA), e.g., using operator gateway 109b, inputs data about one or more service features of Operator B. For example, data for field 314 and field 316 are provided in one or more messages 510b and stored in operator service features data structure 230. One or more messages from other network operators, not shown, as well as messages 510a and messages 510b, are collectively referenced hereinafter as operator input messages 510. These operator input messages 510 are input to API module 210 or operator webpage module 220 depicted in FIG. 2 for the cross-operator service bundle support module 150.

In process 520 these operator service features are bundled with vendor services in a database, such as matched bundle data structure 260 depicted in FIG. 2. In an illustrated embodiment, process 520 is performed by vendor input to vendor interface module 250 in the cross-operator service bundle support module 150. As a result of process 520, data in field 312 of vendor services data structure 240 are associated in matched bundles data structure 260 with the data in field 314 and field 316 of operator service features data structure 230. Thus module 150 causes, at least in part, actions that result in associating data that indicates the service provided by the vendor with data that indicates the service feature of the network operator, in response to receiving data that indicates the service feature of the network operator. In some embodiments, module 150 stores, in a data structure, a record that associates the service provided by the vendor, e.g., in field 312, with the service feature, e.g., in field 316, of the network operator, e.g., field 314. Over time, the data structure comprises a plurality of records, each record holding data that indicates a unique association of one service of a plurality of services provided by the vendor with one or more service features of one or more network operators.

In one or more messages 530, a consumer operates browser 107 to request available services from the vendor store. In some embodiments the request messages 530 includes data that uniquely indicates the consumer, such as the MSISDN or IMSI of the consumer or consumer's UE 101. In some embodiments, the request message 530 includes the UE 101 properties, e.g., model number, serial number, operating system and operator network, if any. For example, in response to browser 107 visiting vendor store 120, a web page including interface 400 is presented by the browser 107 on a display of the UE 101. At first, in some embodiments, the bundle display area 410 is blank and only service icons 420 indicating various categories of service are presented. By selecting one icon, e.g., selecting icon 420b by touching a touch screen at a position of icon 420b, the request message 530 is sent to the vendor store 120 where it is intercepted by the cross-operator service bundle support module 150. In other embodiments, upon accessing the vendor store 120 a list of one or more bundles, e.g., for the most popular category of services for the make and model of the UE, are included in display area 410.

In response to receiving the request message 530 for available services, the module 150 sends one or more available bundles response messages 540, e.g., in one or more HTTP messages to the browser 107 on UE 101 or other messages to a different client process on UE 101. Each message includes at least a portion of an entry from the matched bundles data structure 300, such as fields 310, 312, 314 and 316, for services that comply with the default category or category selected by the user. Data from these fields are used to construct the areas 412, 414, 416 and 418 in bundle display area 410 for each bundle that complies with the category. In some embodiments, the bundles presented are based, at least in part, on the context information associated with the UE 101. The consumer is prompted to select a bundle.

Thus module 270 of module 150, generates a view to be presented on a display. The view comprises data that indicates a service provided by the vendor over the network, such as a service in a category indicated by the consumer or inferred from the consumer's context. The module 150 further determines whether the service is associated with a service feature of a network operator of at least a portion of the network, e.g., in matched bundles data structure 260 retrieved by module 270. If not, only the vendor's service is included in the view. However, if the service is associated with the service feature of the network operator, then data that indicates the service feature of the network operator is inserted into the view. The view is provided for transmission over the network.

In response to a selection by the consumer, one or more messages 550 indicating the consumer's selection, e.g., by value of list number presented in area 412, is sent to the vendor store 120 where the message is intercepted by the module 150. Then during process 560, the module 150 activates the vendor service, such as registering the consumer for one or more network services 110 provided by the vendor. Thus, the module further causes, at least in part, actions that result in providing the service provided by the vendor to equipment of a consumer, in response to receiving data that indicates the consumer and the service provided by the vendor. In some embodiments in which the consumer does not already have equipment and a network operator, the module 150 also executes process 590 depicted as a dotted looping arrow, to cause new equipment for the consumer to be obtained and configured.

The module 150 then sends one or more activate operator feature messages 562, such as message 370 formatted as a roaming message like TAP, for use by the network operator, e.g., at operator gateway 109a. Thus, the module 150 further causes, at least in part, actions that result in providing the service feature of the network operator to equipment of a consumer, in response to receiving data that indicates the consumer and the service provided by the vendor, where the service provided by the vendor is associated with the service feature of the network operator. In some embodiments, the module 150 also notifies the consumer, in one or more messages 564, that the bundled services have been activated. In at least some embodiments, therefore, message 370 indicates the consumer and the service feature. In some embodiments, the message is formatted according to a roaming message protocol. In some embodiments, the message includes data that indicates a price for the service feature, e.g., in field 378. In some embodiments, the message includes data that indicates a charge to the consumer for the service provided by the vendor, e.g., in field 384.

In some embodiments in which the consumer does not already have equipment and a network operator, the module 150 also causes the new and configured equipment to be delivered to the consumer, as represented by the thick dotted arrow labeled 592, which does not terminate at the browser 107 on the UE but goes beyond to suggest the consumer is recipient not the UE 101. Thus, module 150 further causes, at least in part, actions that result in delivering, to the consumer, new equipment configured to access the service with the service feature of the network operator.

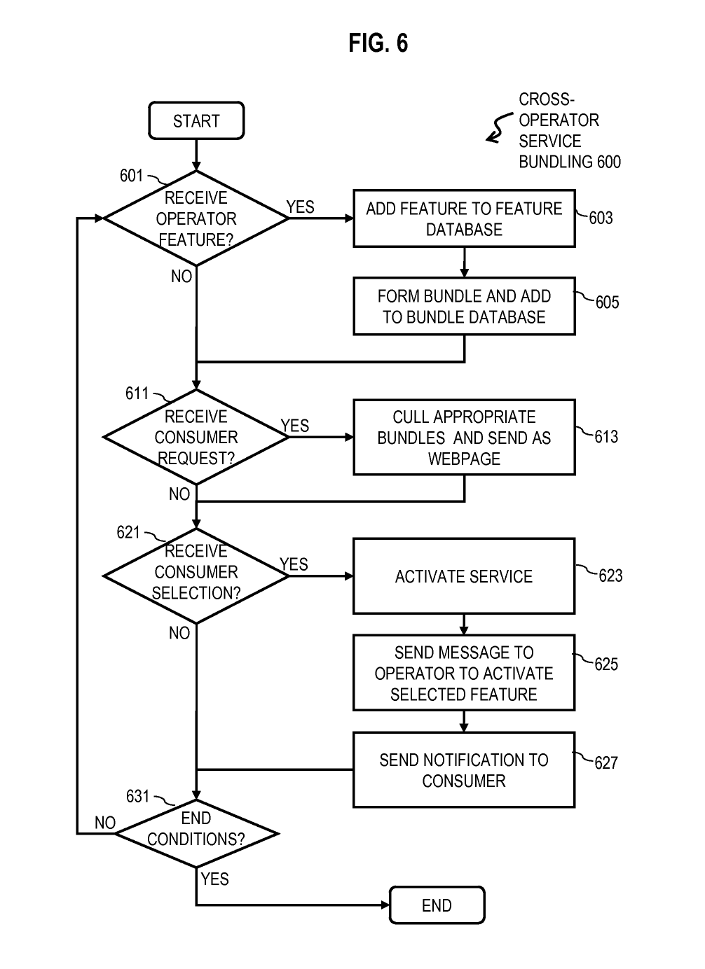

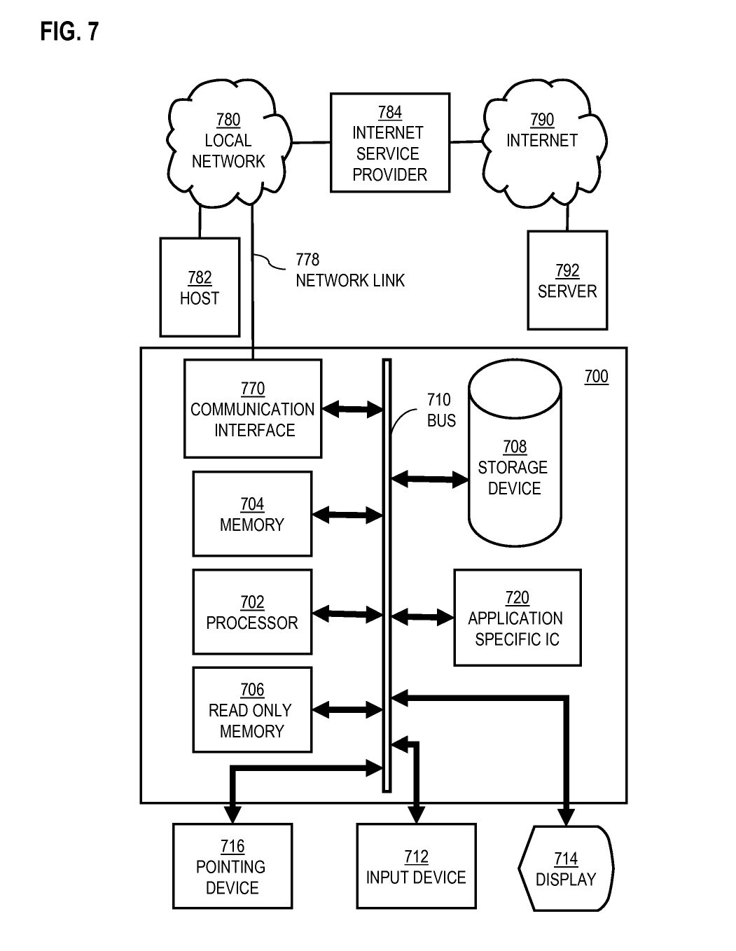

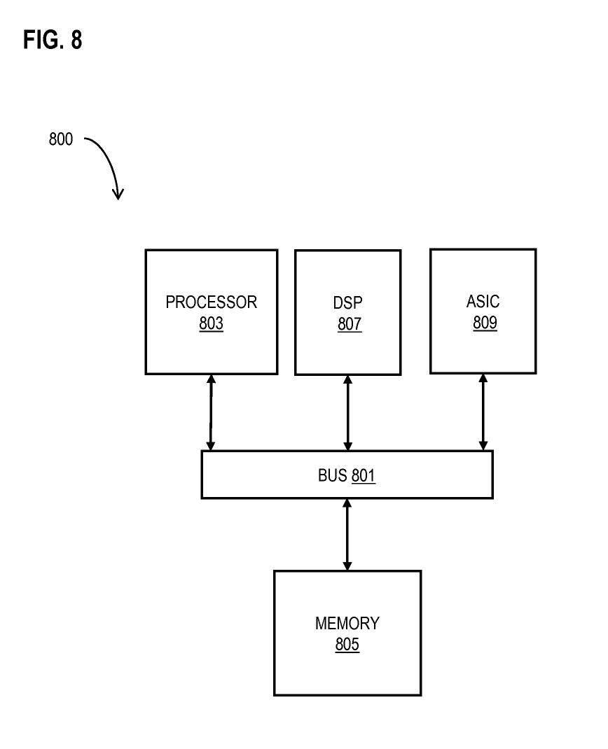

FIG. 6 is a flowchart of a process for bundling services of network service providers and network operators, according to one embodiment. In one embodiment, the cross-operator service bundle support module 150 performs the process 600 and is implemented in, for instance, a chip set including a processor and a memory as shown FIG. 8, or a general purpose computer depicted in FIG. 7. Although the process is depicted in FIG. 6 as integral steps in a particular order for purposes of illustration, in other embodiments, one or more steps, or portions thereof, are performed in a different order, or overlapping in time, performed in series or parallel, or are omitted, or one or more other steps are added, or the process is changed in some combination of ways.

In step 601, it is determined whether data indicating an operator service feature has been received. For example, it is determined whether a message 510 is received at API module 210 or operator webpage module 220. If so, then in step 603, the operator service feature is added to a feature database, such as operator service features data structure 230. In step 605, the new operator service feature is added to one or more bundles in a database, such as one or more records in matched bundles data structure 260 by virtue of vendor input to vendor interface module 250 and data in the vendor services data structure 240. Steps 603 and 605 constitute process 520 depicted in FIG. 5.

In step 611, it is determined whether data indicating a request for bundled services is received from a consumer. For example, it is determined whether an HTTP message 530 to vendor store 120 is intercepted by the cross-operator service bundle support module 150. If so, then in step 613, appropriate bundles are culled from the matched bundles data structure and sent to the consumer's UE, e.g., in one or more web pages presented to the consumer by browser 107 or some other client process on UE 101. In some embodiments, the bundles presented are based, at least in part, on the context information associated with the UE 101, such as make and model of equipment, the contracts or the consumer's current service plan. For example the data describing the bundles culled from the matched bundles data structure are used to form the bundle display area 410 for a webpage returned to the UE 101, such as in Table 1. In an illustrated embodiment, step 613 and following steps 621, 623, 625, and 627 are performed by the bundle service module 270.

In step 621, it is determined whether data is received that indicates a selection of a bundle by the consumer. For example, it is determined whether an HTTP message is received from browser 107 indicating one value from the list number areas 412 in bundle display area 410. If not, then in step 631 it is determined whether end conditions are satisfied, e.g., shutdown conditions for a host for vendor store 120. If so, then the process ends. Otherwise control cycles back to check messages in steps 601, 611 and 621.

If it is determined, in step 621, that data is received that indicates a selection of a bundle by the consumer, then in step 623 the selected service is activated. For example, the consumer is registered for email service provided by the cellular telephone manufacturer. In step 625 a message is sent that causes the network operator for the consumer to activate the selected feature, such as phone with unlimited text and data. In some embodiments, a message 370 is sent to a gateway for the operator or a third party that reformats the message to a roaming format. In some embodiments, a roaming message is sent formatted according to a known roaming protocol, such as a TAP file. In some embodiments, the message 370 includes only the consumer ID field 372 and the feature code field 376. In some embodiments, the network operator bills the consumer for the network services 110 and the message 370 includes vendor ID field 380, service code field 382 and vendor bill amount field 384. In some embodiments, the consumer is not registered with the network operator that provides the selected service feature and the message includes data useful for registering the consumer with a particular operator, such as operator ID field 374. In some embodiments, the operator offers multiple price options for the same service feature, and the price code field 378 is included in the message 370. Steps 623 and 625 constitute process 560 depicted in FIG. 5.

In step 627, the consumer is notified of the successful (or failed) activation of the selected service. For example, a web page is send as an HTTP message to the browser 107 indicating the result of the service activation request. In some embodiments, the bundled service involves a new network operator and or equipment and step 627 includes causing actions that result in a different piece of user equipment being obtained, configured and delivered to the consumer. Control then passes to step 631, described above.

In some, embodiments, step 623 or step 625 or step 627 includes determining whether a feature or service is unavailable to receive consumer requests. If so, then during step 627 the consumer will be prompted to “try again later” or something similar.

The processes described herein for providing bundling services of network service providers and network operators may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to bundle services of network service providers and network operators as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of bundling services of network service providers and network operators.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to bundling services of network service providers and network operators. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for bundling services of network service providers and network operators. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for bundling services of network service providers and network operators, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for bundling services of network service providers and network operators at the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to bundle services of network service providers and network operators as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of services. Chip set or chip 800, or a portion thereof, constitutes a means for performing one or more steps bundling services of network service providers and network operators.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to bundle services of network service providers and network operators. The memory 805 also stores the data associated with or generated by the execution of the inventive steps.

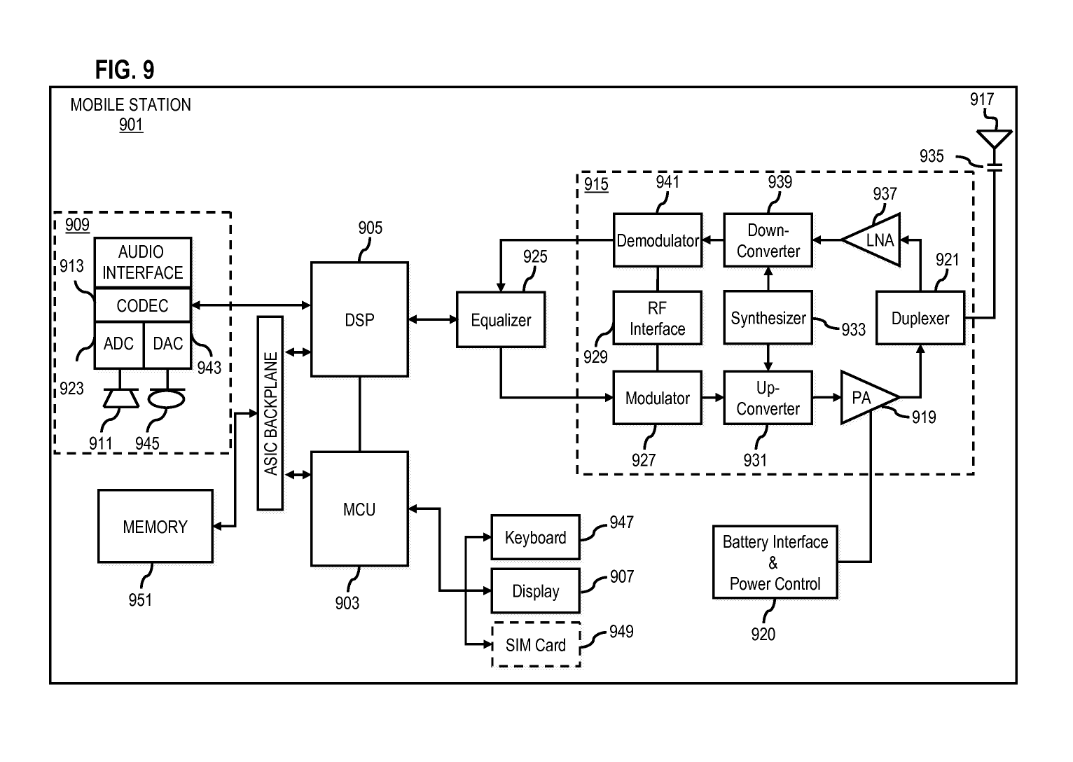

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of bundling services of network service providers and network operators. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of bundling services of network service providers and network operators. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to bundle services of network service providers and network operators. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
generating a view to be presented on a display, the view comprising data that indicates a service provided by a vendor over a network;
determining whether the service is associated with a service feature of a network operator of at least a portion of the network;
if the service is associated with the service feature of the network operator, then inserting into the view data that indicates the service feature of the network operator; and
providing the view for transmission over the network.

2. A method of claim 1, further comprising causing, at least in part, actions that result in providing the service feature of the network operator to equipment of a consumer, in response to receiving data that indicates the consumer and the service provided by the vendor, wherein the service provided by the vendor is associated with the service feature of the network operator.

3. A method of claim 1, further comprising causing, at least in part, actions that result in providing the service provided by the vendor to equipment of a consumer, in response to receiving data that indicates the consumer and the service provided by the vendor.

4. A method of claim 1, further comprising causing, at least in part, actions that result in associating data that indicates the service provided by the vendor with data that indicates the service feature of the network operator, in response to receiving data that indicates the service feature of the network operator.

5. A method of claim 2, wherein causing, at least in part, actions that result in providing the service feature of the network operator to equipment of the consumer further comprises causing, at least in part, actions that result in sending, to the network operator, a message that indicates the consumer and the service feature.

6. A method of claim 4, wherein causing, at least in part, actions that result in associating data that indicates the service provided by the vendor with data that indicates the service feature of the network operator further comprises causing, at least in part, actions that result in storing a record that associates the service provided by the vendor with the service feature of the network operator in a data structure.

7. A method of claim 6, wherein the data structure further comprises a plurality of records, each record holding data that indicates a unique association of one service of a plurality of services provided by the vendor with one or more service features of one or more network operators.

8. A method of claim 1, wherein the network operator is different from the vendor that provides the service.

9. A method of claim 5, wherein sending, to the network operator, the message that indicates the consumer and the service feature further comprises sending to the network operator the message formatted according to a roaming message protocol.

10. A method of claim 5, wherein sending, to the network operator, the message that indicates the consumer and the service feature further comprises including, in the message, data that indicates a price for the service feature.

11. A method of claim 5, wherein sending, to the network operator, the message that indicates the consumer and the service feature further comprises including, in the message, data that indicates a charge to the consumer for the service provided by the vendor.

12. A method of claim 2, wherein causing, at least in part, actions that result in providing the service feature of the network operator to equipment of the consumer further comprises causing, at least in part, actions that result in delivering, to the consumer, new equipment configured to access the service with the service feature of the network operator.

13. An apparatus comprising:
at least one processor; and
at least one memory including computer program code, the at least one memory and the computer program code configured to, with the at least one processor, cause the apparatus to perform at least the following,
generate a view to be presented on a display, the view comprising data that indicates a service provided by a vendor over a network;
determine whether the service is associated with a service feature of a network operator of at least a portion of the network;
if the service is associated with the service feature of the network operator, then insert into the view data that indicates the service feature of the network operator; and
provide the view for transmission over the network.

14. An apparatus of claim 13, wherein the apparatus is further caused, at least in part, to perform actions that result in providing the service feature of the network operator to equipment of a consumer, in response to receiving data that indicates the consumer and the service provided by the vendor, wherein the service provided by the vendor is associated with the service feature of the network operator.

15. An apparatus of claim 13, wherein the apparatus is further caused, at least in part, to perform actions that result in associating data that indicates the service provided by the vendor with data that indicates the service feature of the network operator, in response to receiving data that indicates the service feature of the network operator.

16. An apparatus of claim 13, wherein to cause, at least in part, actions that result in providing the service feature of the network operator to equipment of the consumer further comprises to cause, at least in part, actions that result in sending, to the network operator, a message that indicates the consumer and the service feature.

17. An apparatus of claim 16, wherein sending, to the network operator, the message that indicates the consumer and the service feature further comprises sending to the network operator the message formatted according to a roaming message protocol.

18. A method comprising facilitating access to an interface to allow access to a service via a network, the service configured to:
generate a view to be presented on a display, the view comprising data that indicates a particular service provided by a vendor over a network;
determine whether the particular service is associated with a service feature of a network operator of at least a portion of the network;
if the particular service is associated with the service feature of the network operator, then insert into the view data that indicates the service feature of the network operator; and
provide the view for transmission over the network.

19. A method of claim 18, wherein the service is further configured to cause, at least in part, actions that result in providing the service feature of the network operator to equipment of a consumer, in response to receiving data that indicates the consumer and the service provided by the vendor, wherein the service provided by the vendor is associated with the service feature of the network operator.

20. A method of claim 18, wherein the service is further configured to cause, at least in part, actions that result in associating data that indicates the service provided by the vendor with data that indicates the service feature of the network operator, in response to receiving data that indicates the service feature of the network operator.

21-74. (canceled)
